(19) United States
(12) Patent Application Publication
(10) Pub. No.: US 2026/0284946 A1
(43) Pub. Date: Sep. 24, 2026

(54) SHIM FOR PLUGGING THE BLIND CAVITY OF A SLEEVE

(71) Applicants: SAFRAN AIRCRAFT ENGINES, Paris (FR); Safran Aerospace Composites LLC, Rochester, NH (US)

(72) Inventors: Nicolas Quang-Ninh TRAN, MOISSY-CRAMAYEL (FR); Hubert Jean Marie FABRE, MOISSY-CRAMAYEL (FR); Micah Christian GUMMEL, MOISSY-CRAMAYEL (FR); Pascal Francis Patrick GOMEZ, MOISSY-CRAMAYEL (FR)

(73) Assignees: SAFRAN AIRCRAFT ENGINES, Paris (FR); Safran Aerospace Composites LLC, Rochester, NH (US)

(21) Appl. No.: 19/082,288

(22) Filed: Mar. 18, 2025

(51) Int. Cl. B29C 45/14; B29B 11/14; B29L 31/08

(52) U.S. Cl. CPC B29C 45/14754; B29B 11/14; B29C 2045/1477; B29L 2031/082

(57) ABSTRACT

A shim includes a body including a rod, the body for being placed in an inserted position in which the rod is inside a blind cavity, a seal extending around the rod, the seal for plugging an annular space provided between the rod and a sleeve and for defining a chamber with the rod and a bottom of the blind cavity while the body is in the inserted position. a passage passing through the body for conveying air between the chamber and an outside of the sleeve, when the body is in the inserted position, a closure system for adopting, while the body is in the inserted position, a closed configuration in which the closure system closes the passage to fluidically isolate the chamber and an open configuration in which the closure system enables the passage to convey air between the chamber and the outside of the sleeve.

### TECHNICAL FIELD

The present disclosure relates to a shim for plugging the blind cavity of a sleeve, the sleeve forming, for example, part of a turbine machine blade.

### BACKGROUND

A turbomachine blade comprising a preform which surrounds a sleeve defining a blind cavity is known. The preform is made of a composite material. A resin is injected into the preform during the manufacture of the blade.

For certain reasons, the injection of resin is carried out when the preform is already located around the sleeve.

However, the blind cavity of the sleeve must remain empty. Therefore, any resin accumulated in the blind cavity of the sleeve must be removed after the injection, in an additional cleaning step. This has the effect of making the manufacture of the blade more complex.

### DISCLOSURE OF THE INVENTION

An object of the invention is to avoid the accumulation of resin in a blind cavity of the sleeve.

This object is achieved by a shim for plugging a sleeve defining a blind cavity, the shim comprising: a body comprising a rod, the body being suitable for being placed in an inserted position in which the rod is inside the blind cavity; a seal extending around the rod, the seal being suitable for plugging an annular space provided between the rod and the sleeve and for delimiting a chamber with the rod and a bottom of the blind cavity when the body is in the inserted position; a passage passing through the body for conveying air between the chamber and the outside of the sleeve when the body is in the inserted position; a closure system suitable for adopting, while the body is in the inserted position: a closed configuration in which the closure system closes the passage, so as to fluidically isolate the chamber from the outside of the sleeve, and an open configuration in which the closure system enables the passage to convey air between the chamber and the outside of the sleeve.

In itself, the presence of the rod inside the blind cavity limits a significant accumulation of resin in the blind cavity, during a resin injection step, since the space occupied by the rod cannot be occupied by the resin. In addition, the seal prevents the resin from accumulating in the chamber, which is located at the very bottom of the blind cavity.

Furthermore, the air passage enables the shim to be inserted in the sleeve or to be withdrawn from the sleeve without force. During the insertion, the volume of the chamber is reduced and the air can be evacuated to the outside of the sleeve. If the air could not be evacuated via the air passage, an increase in pressure would be produced inside the chamber. Once the shim is no longer pushed towards the bottom of the blind cavity, the shim would be moved in the opposite direction by the “piston effect” alone, so as to reduce the pressure in the chamber. The presence of the passage in the shim avoids this phenomenon, so that when the body has reached the desired inserted position, it can remain there even when pushing of the shim has stopped.

In addition, the closure system has the advantage, in its closed configuration, of holding the shim in this inserted position. More specifically, if the shim moves towards the outside of the sleeve (for example due to gravity, when the shim is below the sleeve, or due to any other undesired external stress), the volume of the chamber increases but, since the chamber is fluidically isolated from the outside of the sleeve, the pressure inside the chamber reduces. However, as soon as the shim ceases to be stressed, it will return naturally to the inserted position, in order that the chamber regains its initial pressure. Thus, in the closed position and in combination with the seal, the closure system uses the piston effect for the purpose of stabilising the shim in the inserted position, whereas this piston effect was undesirable during the insertion of the rod in the sleeve.

Finally, the closure system allows easy extraction of the rod from the sleeve in its open configuration, since, in this configuration, no piston effect is produced (the air can be freely conveyed from the outside to the chamber via the air passage).

Ultimately, the above-cited features not only avoid a significant accumulation of resin in the blind cavity, but also facilitate the insertion of the shim, its holding in the inserted position, and its withdrawal from the sleeve.

The shim, which constitutes a first object of the present disclosure, can also comprise the following optional features, taken alone or in combination.

The air passage preferably comprises a distal orifice and a proximal orifice opposite the distal orifice, the distal orifice opening into the chamber when the shim is in the inserted position, and the proximal orifice opening to the outside of the sleeve when the body is in the inserted position, and the closure system comprises a plug suitable for adopting, while the body is in the inserted position: a closed position in which the plug covers the proximal orifice, and an open position in which the plug uncovers the proximal orifice.

The air passage preferably comprises a straight duct going from the proximal orifice to the distal orifice.

The air passage preferably comprises an additional orifice suitable for opening to the outside of the sleeve when the body is in the inserted position, the additional orifice being distinct from the proximal orifice, and the closure system comprises an additional plug suitable for, while the body is in the inserted position: a closed position in which the additional plug covers the additional orifice while the plug is in the open position, and an open position in which the additional plug uncovers the additional orifice while the plug is in the closed position.

The additional orifice is preferably oriented perpendicular to the proximal orifice.

The rod preferably has a cylindrical outer surface suitable for being aligned with a radial outer edge of the seal.

The seal is preferably arranged relative to the cylindrical outer surface so as to be inserted in the blind cavity before the cylindrical outer surface.

The body preferably comprises an annular shoulder suitable for being in abutment on an annular edge of the sleeve defining an access to the blind cavity, when the body is in the inserted position.

The shim preferably further comprises a porous element arranged in the passage in order to allow air to pass and to block a resin.

The shim preferably further comprises a second seal extending around the rod, the second seal being suitable for plugging the annular space provided between the rod and the sleeve at the same time as the seal, when the body is in the inserted position.

A second object of the present disclosure is a method of manufacturing a product, the product comprising a sleeve defining a blind cavity and a preform extending around the sleeve, the method comprising the following steps carried out in sequence using the shim constituting the first object of the present disclosure, in order to plug the sleeve:
placing the body in the inserted position;
putting the closure system in the closed configuration;
injecting a resin into the preform, while the preform is around the sleeve,
putting the closure system in the open configuration; and
extracting the body out of the sleeve.

The product is preferably a turbomachine blade or a part of a turbomachine blade.

A third object of the present disclosure is an assembly comprising a sleeve defining a blind cavity, and a shim according to the first object.

Preferably, the sleeve has a cylindrical inner surface that is complementary to the cylindrical outer surface of the shim discussed above.

A fourth object of the present disclosure is a system for manufacturing a product comprising a sleeve defining a blind cavity and a preform extending around the sleeve, the system comprising: the assembly constituting the third object of the present disclosure, and a mould configured to form the preform using a resin injected into the interior of the mould while the assembly is inside the mould.

The mould preferably comprises a wall suitable for coming into contact with the additional plug, while the resin is injected inside the mould.

### DESCRIPTION OF THE FIGURES

Other features, aims and advantages of the invention will emerge from the following description, which is given purely by way of illustration and not being limiting and which should be read with reference to the attached drawings, in which:

FIG. 1 is a partial sectional view of a turbomachine blade according to an embodiment.

FIG. 2 is a sectional view of a shim according to a first embodiment.

FIG. 3 is a sectional view showing the blade of FIG. 1 and the shim of FIG. 2 in an inserted position.

FIG. 4 is a sectional view showing the blade of FIG. 1 and the shim of FIG. 2 in a partially inserted position.

FIG. 5 is another sectional view showing the blade of FIG. 1 and the shim of FIG. 2 in the inserted position.

FIG. 6 is another sectional view showing the blade of FIG. 1, the shim of FIG. 2 in the inserted position and a mould during a resin injection step.

FIG. 7 is a sectional view showing the blade of FIG. 1 and a shim according to a second embodiment in an inserted position.

FIG. 8 is another sectional view showing the blade of FIG. 1, the shim of FIG. 7 in the inserted position and a mould, during a resin injection step.

FIG. 9 is a sectional view showing the blade of FIG. 1 and a shim according to a third embodiment in an inserted position.

In all the figures, similar elements have identical reference signs.

### DETAILED DESCRIPTION OF THE INVENTION

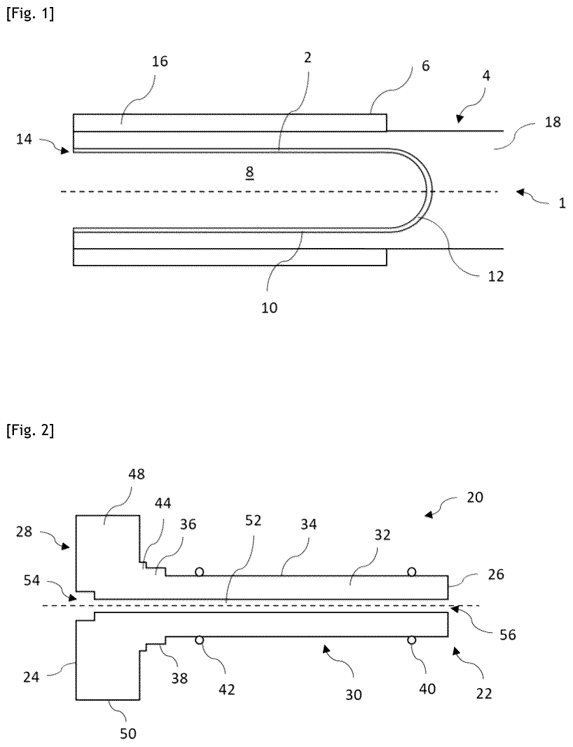

With reference to FIG. 1, a turbomachine blade 1 comprises an inner sleeve 2, a preform 4 and an outer sleeve 6.

The inner sleeve 2 delimits a blind cavity 8. The sleeve 2 comprises an annular wall 10 extending around an axis (represented by a dotted line in FIG. 1), and a bottom wall 12, the two walls 10, 12 together defining the blind cavity 8.

The annular wall 10 has an inner surface facing the axis, and an outer surface opposite the inner surface, the outer surface surrounding the inner surface. The inner surface is cylindrical and parallel to the axis.

The annular wall 10 has an annular edge 14 defining an access orifice to the blind cavity 8, this annular edge 14 being opposite the bottom wall 12 relative to the annular wall 10. When the inner surface is rotationally symmetric, the access orifice is a circular orifice.

In the present text, the term “blind” cavity shall mean a cavity which is only accessible via a single orifice. It is thus understood that a cavity that is simultaneously accessible via two orifices is not a blind cavity.

The bottom wall 12 has an inner surface forming a bottom of the blind cavity 8. This inner surface prolongs the inner surface of the annular wall 10, for example continuously. In the illustrated embodiment, this inner surface has a concave profile; in particular, in may be hemispherical.

The inner sleeve 2 is made of metal or of a composite material.

The preform 4 comprises two parts: an attachment part 16 and an aerodynamic part 18.

The attachment part 16 extends around the inner sleeve 2, more precisely around the axis (thus around the annular wall 10 of the inner sleeve 2).

The aerodynamic part 18 is located above the sleeve, such that the bottom wall 12 is situated between the aerodynamic part 18 and the annular wall 10 of the inner sleeve 2. The aerodynamic part 18, sometimes called an aerofoil, is intended to be immersed in a flow so as to be rotated, when the blade 1 is mounted on the hub of a turbomachine. The aerodynamic part 18 typically has a pressure side and a suction side opposite the pressure side. The aerodynamic part 18 is only partially represented in FIG. 1.

The inner sleeve 2, the attachment part 16 of the preform 4, and the outer sleeve 6 together form a root of the blade 1. While the aerodynamic part 18 is intended to be immersed in a flow, the function of the root is to attach the blade 1 to a turbomachine hub that is suitable for being rotated relative to a casing of the turbomachine.

The preform 4 is produced as a single piece from a composite material, by 3D weaving. The preform is fibrous.

The preform 4 is impregnated with a thermosetting resin. The resin was injected in the preform 4 during a method for manufacturing the blade 1 which will be described below. The resin enables the voids in the fibrous preform to be filled and provides the desired mechanical properties of the final part.

The outer sleeve 6 extends around the attachment part 16. A function provided by the outer sleeve 6 is to absorb forces during start-up of the turbomachine.

The outer sleeve 6 typically has a rotationally symmetric outer surface, so as to enable rotation of the blade 1 around the axis, with respect to the hub. When this rotation is allowed, it is said that the blade 1 has variable pitch.

The outer sleeve 6 delimits a through-cavity (and not a blind cavity, unlike the inner sleeve 2). The through-cavity is passed through by the attachment part 16 of the preform 4.

The outer sleeve 6 is made of metal, for example steel, titanium or Inconel.

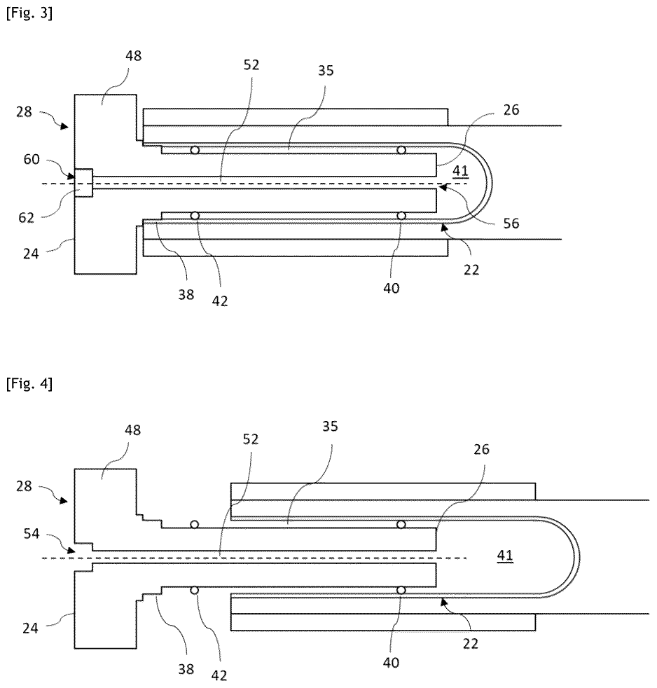

FIG. 2 and FIG. 3 show a shim 20 suitable for plugging the blind cavity of the inner sleeve 2. The shim 20 is used to prevent an accumulation of the resin accumulating in this blind cavity 8 during the injection of resin into the preform 4. This blind cavity 8 is in fact intended to remain empty after the injection.

The shim 20 comprises a body 22 with elongated shape along a longitudinal axis from a proximal edge 24 to a distal edge 26 opposite the proximal edge 24. In FIG. 2, the longitudinal axis is represented by a dotted horizontal line.

The body 22 comprises two parts extending along the longitudinal axis: a proximal part 28 defining the proximal edge 24, and a rod 30 defining the distal edge 26.

The rod 30 is suitable for being inserted in the blind cavity 8 via the access, following a translational movement along the axis, towards the bottom wall 12, until the body 22 reaches an inserted position shown in FIG. 3. In the inserted position, the axis of the shim 20 and the longitudinal axis of the body 22 are coincident.

The rod 30 comprises a first portion 32 which is terminated by the distal end 26. The first portion 32 has a first outer surface 34 extending around the longitudinal axis.

The second outer surface 38 is adapted so that an annular space 35 (see FIG. 3) is provided between this second outer surface 38 and the inner surface of the sleeve when the rod 30 is in the inserted position in the blind cavity 8. The first outer surface 34 has a first diameter.

The first outer surface 34 is preferably rotationally symmetric. When the inner surface of the inner sleeve 2 is also rotationally symmetric, the annular space 35 is then in the form of a circular ring. The first outer surface 34 may be cylindrical but is not necessarily so. It can, in particular, have a non-zero clearance angle.

The rod 30 comprises a second portion 36 which prolongs the first portion 32. The second portion 36 has a second outer surface 38 extending around the longitudinal axis. The second outer surface 38 is cylindrical and complementary to the cylindrical inner surface of the inner sleeve 2. The second portion 36 has the effect of guiding the rod 30 in translation during its insertion in the blind cavity 8, or during a subsequent withdrawal of the rod 30 from the blind cavity 8. In particular, the second portion 36 prevents rotation of the shim 20 with respect to the inner sleeve 2 around a transverse axis perpendicular to the axis of the inner sleeve 2.

The second outer surface 38 may be rotationally symmetric around the longitudinal axis, but is not necessarily so. The first outer surface 34 has a second diameter greater than the first diameter.

The second outer surface 38 is connected to the first outer surface 34 by a shoulder.

The shim 20 further comprises a seal 40. The seal 40 extends around the rod 30. A function ensured by the seal 40 is that of plugging the annular space formed between the rod 30 and the inner sleeve 2 when the shim 20 is in the inserted position. The seal 40 extends around the first portion 32 of the rod 30. The seal 40 is fixed on the first outer surface 34, for example by gluing.

In the inserted position of the shim 20, the seal 40 delimits a chamber 41 with the rod 30 and the bottom of the blind cavity 8 (see FIG. 3).

The seal 40 is for example toroidal, when the first outer surface 34 is rotationally symmetric.

The shim 20 also comprises a second seal 42 for likewise plugging the annular space formed between the rod 30 and the inner sleeve 2 when the shim 20 is in the inserted position. The two seals 40, 42 extend in two parallel planes having respectively different positions along the longitudinal axis. The second seal may have the features described above for seal 40.

Each seal 40, 42 has a radially outer edge suitable for being aligned with the cylindrical surface. This alignment can be obtained by using seals, the thickness of which is substantially equal to a difference in radius between the first outer surface 34 and the second outer surface 38, or slightly greater than this difference if the joints are compressible in a centripetal direction (towards the longitudinal axis).

The proximal part 28 of the body 22 is suitable for resting on the outside of the inner sleeve 2 while the rod 30 is located inside the blind cavity 8 of the inner sleeve 2.

The proximal part 28 comprises a third portion 44 which prolongs the rod 30 (more precisely, the second portion 36 of the rod 30). The third portion 44 has a third outer surface 46 extending around the longitudinal axis. The third outer surface 46 can be rotationally symmetric and/or cylindrical, but is not necessarily so. The third outer surface 46 has a third diameter greater than the second diameter. The third diameter may substantially correspond to the diameter of the outer surface of the inner sleeve 2.

The third outer surface 46 is connected to the second outer surface 38 by an annular shoulder suitable for coming into abutment against the annular edge 14 of the sleeve, when the shim 20 is in the inserted position. Thus, the third portion 44 limits the insertion travel of the shim 20 inside the blind cavity 8 of the inner sleeve 2.

The proximal part 28 further comprises a fourth portion 48 which prolongs the third portion 44. The fourth portion 48 has a fourth outer surface 50 extending around the longitudinal axis. The fourth outer surface 50 can be rotationally symmetric and/or cylindrical, but is not necessarily so. The fourth outer surface 50 has a fourth diameter greater than the third diameter.

The fourth portion 48 is facing the preform 4, but at a distance therefrom when the shim 20 is in the inserted position. In the inserted position, the fourth portion 48 and the preform 4 are separated by a second annular space. It will be seen below that this second annular space is passed through by the injected resin just before reaching the preform 4.

The body 22 comprises a through-passage 52 for conveying air between the above-mentioned chamber 41 and the outside of the inner sleeve 2, when the shim 20 is in the inserted position. Air located in the chamber 41 can thus be evacuated to the outside of the inner sleeve 2. On the other hand, air coming from outside the inner sleeve 2 can penetrate into the chamber 41.

The passage 52 comprises a proximal orifice 54 delimited by the proximal edge 24 of the body 22, and a distal orifice 56 delimited by the distal edge 26 of the body 22.

The passage 52 comprises a straight duct extending from the proximal orifice 54 to the distal orifice 56. The straight duct is parallel to the longitudinal axis. The straight duct is centred on this longitudinal axis.

The shim 20 further comprises a closure system 60. The closure system 60 is suitable for adopting a closed configuration and an open configuration, while the shim 20 is in the inserted position (the rod 30 is inside the blind cavity 8 while the proximal part 28 remains outside thereof).

In the closed configuration (see FIG. 3), the closure system 60 closes the passage 52, so as to fluidically isolate the chamber 41 from the outside of the sleeve.

In the open configuration (see FIG. 2), the closure system 60 allows the passage 52 to convey air between the chamber 41 and outside of the sleeve, as previously indicated.

The closure system 60 comprises a plug 62 suitable for adopting, while the body 22 is in the inserted position, a closed position in which the plug 62 covers the proximal orifice 54, and an open position in which the plug 62 uncovers the proximal orifice 54. Thus, the plug 62 is intended to cooperate mechanically with the proximal part 28 of the body 22, more precisely with the fourth portion 48 of the body 22, which enables its closure and its opening when the shim 20 is in the inserted position. The plug 62 can, for example, be screwed on the body 22.

A method for manufacturing the turbomachine blade 1 comprises the following steps.

In an assembly step, the attachment part 16 of the preform 4 is arranged around the inner sleeve 2 and the outer sleeve 6 is arranged around the attachment part 16 of the preform 4, as shown in FIG. 1. At this stage, the preform 4 is not yet impregnated with resin.

The closure system 60 is put into the open configuration (as in FIG. 2).

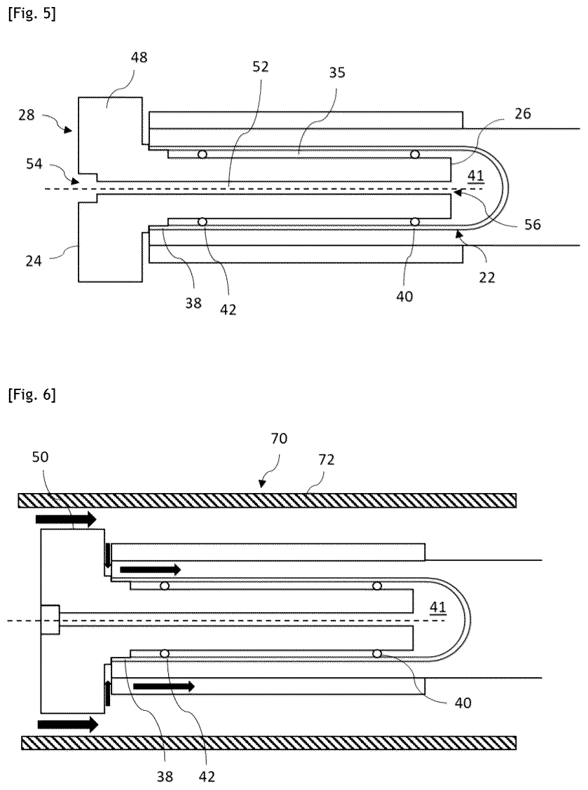

Then, the rod 30 is inserted into the blind cavity 8. When the seal 40 enters into contact with the inner surface of the inner sleeve 2, the chamber 41 discussed above and located between the rod 30 and the bottom of the cavity is formed (see FIG. 4). The rod 30 is moved in translation towards the bottom of the blind cavity 8, until the third portion 44 comes into abutment on the annular edge 14 of the inner sleeve 2. The inserted position of the shim 20 is thus achieved (see FIG. 5).

During the movement in translation, the volume of the chamber 41 reduces. If the closure system 60 was in the closed configuration, or more generally if the chamber 41 was fluidically isolated from the outside before the inserted position was reached, then the reduction in the volume of the chamber 41 would be accompanied by an increase in pressure of the air located in the chamber 41. This pressure increase would cause a “piston effect”, in other words the shim 20 could not be maintained in the inserted position; on the contrary, the accumulated overpressure in the chamber 41 would cause an automatic movement of the shim 20 in the opposite direction, in order to reduce this pressure. However, the closure system 62 is in the open configuration. As the volume of the chamber 41 gradually reduces, the air can freely escape to outside of the sleeve by passing through the passage 52 formed in the body 22. No piston effect is produced, so that the shim 20 can remain naturally in the inserted position when it has stopped being pushed towards the bottom of the inner sleeve 2.

The closure system 60 is put in the closed configuration. The plug 60 then plugs the proximal orifice 54 (see FIG. 3). This enables the shim 20 to be stabilised in the inserted position. More specifically, pulling the shim 20 at this stage increases the volume of the chamber 41, thus causing a negative pressure inside. On releasing the shim 20, it will return naturally to the inserted position, moving in translation towards the bottom of the inner sleeve 2. Thus, whereas the piston effect was undesirable during the insertion of the shim 20, it becomes advantageous for stabilising the shim 20 in the inserted position, once this is reached.

It should be noted that the order of the assembly and insertion steps for the shim 20 can be reversed. More specifically, it is possible to insert the shim 20 in the inner sleeve 2 beforehand.

The assembly formed by the inner sleeve 2, the preform 4, the outer sleeve 6 and the shim 20 in the inserted position is placed inside a mould 70 in an injection position. The mould 70, which is schematically shown in FIG. 6, comprises an annular wall 72 extending around the fourth outer surface 52 and the outer sleeve 4 in the injection position. More precisely, an annular space is provided between the wall 72 and the fourth outer surface 50 of the shim 20.

A resin is then injected inside the mould 70. The path followed by the resin is indicated by the black arrows in FIG. 6. The resin is thermosetting.

The resin flowing in the mould 70 starts to reach the proximal edge 24 of the body 22. The resin cannot penetrate into the air passage 52 due to the presence of the plug 62.

The resin bypasses the fourth portion 48, and flows into the annular space provided between the fourth outer surface 50 and the wall 72 of the mould 70 in a direction parallel to the longitudinal axis of the shim 20. The resin then penetrates into the annular space provided between the fourth portion 48 and the preform 4, flowing in a centripetal direction towards the longitudinal axis of the shim 20. The resin then penetrates into the preform 4 so as to impregnate it, following a direction that is again parallel to the longitudinal axis of the shim 20.

During the injection, the accumulation of resin inside the blind cavity 8 is limited on several levels. Firstly, the fact that the third portion 44 is in abutment on the annular edge 14 of the inner sleeve 2 limits a flow of resin between this third portion 44 and the annular edge 14. Secondly, the complementarity of shape between the second portion 36 of the body 22 and the sleeve also limits the progression of resin further downstream, between the second portion 36 and the third portion 44. Finally, even if a small quantity of resin (or “flash”) manages to make its way between the second portion 36 and the inner sleeve 2, this resin could not reach the chamber 41 due to the seals present.

Once the injection of resin is completed, the assembly is removed from the mould 70.

The closure system 60 is placed in the open configuration, in other words the plug 62 is withdrawn so as to uncover the proximal orifice 54 of the air passage 52.

Then, the shim 20 is moved in translation relative to the inner sleeve 2, so as to extract the rod 30 out of the blind cavity 8. This extraction is made without an undesirable piston effect, due to the fact that the air can be freely conveyed from the outside to the chamber 41, while the volume of the chamber 41 increases.

Due to the presence of the shim 20 during the injection of the resin, the resin is not accumulated in large quantity in the blind cavity 8. If the resin has made its way into the blind cavity 8 despite the presence of the shim 20, its volume remains small, which shortens the subsequent cleaning time of the blind cavity 8. Furthermore, the seals prevent the resin from penetrating into the air passage 52 passing via the distal orifice 56. In such a situation, the resin, once hardened, would permanently obstruct the air passage 52, thus causing a piston effect during a subsequent extraction or insertion of the shim 20, as previously described.

It should be noted that the straight character of the passage 52 remains advantageous for unblocking such a situation, if this should arrive, for example following damaging of a seal 40 or its wear after repeated uses of the shim 20. More specifically, such a passage 52 can be freed of the resin which obstructs it using a drilling tool engaged in the passage 52 via its proximal orifice 54.

Furthermore, it should be noted that the resin can accumulate on the proximal edge 24 of the shim 20, to the point of covering the plug 62 before hardening. It is then necessary to remove this layer of hardened resin, for example by scraping, before being able to open the plug 62 and then remove the shim 20 from the inner sleeve 2.

The shim 20 can be reused a plurality of times during the injection of resin into distinct preforms 4.

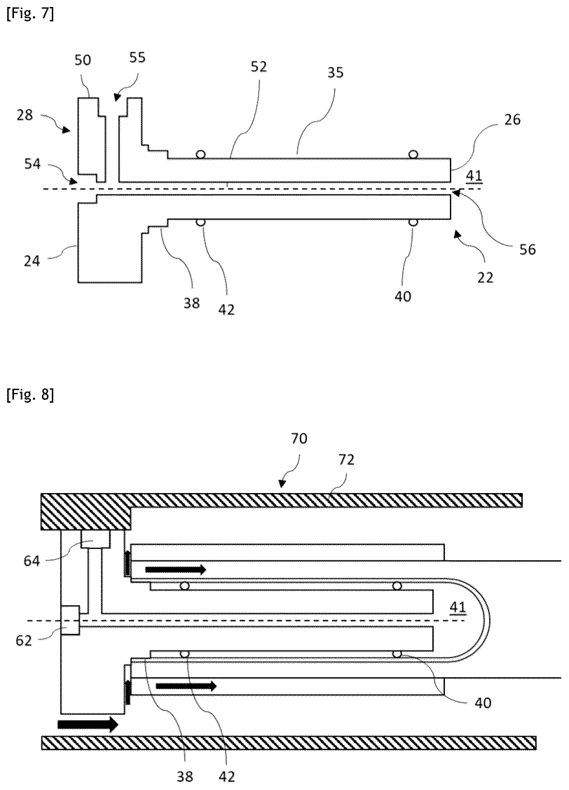

FIG. 7 and FIG. 8 show a second embodiment of the shim 20 which can overcome this problem.

The shim 20 according to the second embodiment comprises all the features which have been described above. The differences between this shim 20 and the previously described shim 20 will now be explained.

The passage 52 further comprises an additional orifice 55 suitable for opening to the outside of the inner sleeve 2 when the shim 20 is in the inserted position. The additional orifice is distinct from the proximal orifice 54.

The additional orifice 55 is oriented perpendicular to the proximal orifice 54. More precisely, the additional orifice opens on the fourth outer surface 50.

The passage 52 comprises not only a main straight duct extending from the distal orifice 56 to the proximal orifice 54, but also an additional duct connecting the additional orifice to the main duct via a junction situated between the proximal orifice 54 and the distal orifice 56. The additional duct is straight and perpendicular to the main duct.

Furthermore, the closure system 60 comprises an additional plug 64 that is distinct and independent of the previously described plug 62. The additional plug 64 is suitable for adopting, while the body 22 is in the inserted position: a closed position in which the additional plug 62 covers the additional orifice, and an open position in which the plug 62 uncovers the additional orifice.

It is intended that the additional plug 62 can change position without plug 62 changing position, and vice-versa. Thus, in order to place the closure system 60 in its open configuration, a user may, by choice, open only plug 62, open only the additional plug 62, or open both plug 62 and 64. By contrast, in order to place the closure system in the closed configuration, the two plugs 62 and 64 are respectively simultaneously positioned on the orifices 54, 55.

Such a shim 20 is advantageously combined with a mould 70 configured to receive the assembly to be injected in a position in which the wall 72 of the mould 70 comes into contact with the additional plug 62. Through this configuration, only a very limited quantity of resin will be able to accumulate on the additional plug 62. Consequently, it is easier, after the injection, to scrape the resin at the additional plug 62 in order to configure the closure system 60 in the open configuration (avoiding the piston effect during the removal of the rod 30 from the blind cavity 8), than to scrape the accumulated resin in larger quantity at the plug 62 arranged on the proximal edge 24.

Ultimately, the previously described method is thus applicable to the shim 20 according to the second embodiment, except that:
before inserting the shim 20 in the inner sleeve 2, the closure system is put into the open configuration by simply opening the plug 62 (the additional plug 62 can be left closed)
after the injection of the resin, the closure system is put into the open configuration by simply opening the additional plug 62 (the loss of time for scraping the resin layer accumulated on the plug 62 is therefore avoided).

In the embodiments just described, the seals 40, 42 may become worn after repeated uses. Consequently, in their worn state, the seals may cease to fulfil their resin blocking function. Furthermore, it has previously been seen that a drilling tool can be used as a last resort in order to hollow out the resin which has infiltrated into the air passage 52.

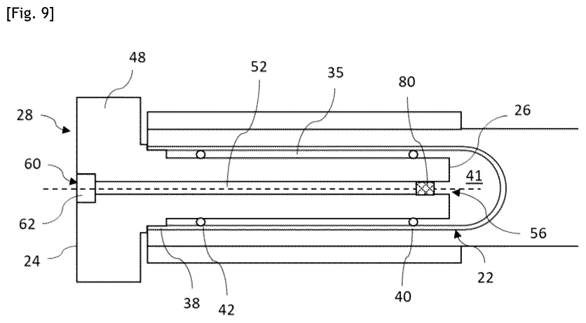

FIG. 9 shows a shim 20 according to a third embodiment, making the drilling easier. For this purpose, the shim 20 comprises a porous element 80, the porous element 80 being suitable for being passed through by air and for blocking the resin. Resin penetrating into the passage 52 via the distal orifice 56 may possibly accumulate between the porous element 80 and the distal orifice 56, but not between the distal orifice 56 and the proximal orifice 54. Since the quantity of accumulated resin is reduced, drilling will be carried out over a smaller distance.

The porous element 80 is preferably closer to the distal orifice 56 than to the proximal orifice 54, in order to further reduce this distance.

The shim 20 according to the third embodiment further comprises all the features of the first embodiment illustrated in FIGS. 2 to 6.

### Other Embodiments

Three embodiments of the shim 20 have been described in relation to the figures. Other variants of the shim 20 are possible.

The specific features of the shim 20 according to the second embodiment (additional orifice, additional plug 62) and the specific features of the shim 20 according to the third embodiment (porous element 80) can be combined in the same shim 20.

It is not obligatory to have two seals in the shim 20. A single one may suffice.

Although very advantageous for the purpose of stabilising and guiding of the shim 20 relative to the inner sleeve 2, the complementarity of shape between the second portion 36 of the body 22 and the inner sleeve 2 remains optional.

Furthermore, the figures have illustrated an inner sleeve 2 having a specific shape. This shape can however be subject to modifications. For example, a clearance angle can be added so as to enable rotational guidance and translational blocking by a conical shape.

Rotational blocking of the shim 20 relative to the sleeve, around the longitudinal axis can be produced by a notch in the sleeve. The notch can contribute to limiting the penetration of resin into the inner sleeve 2.

1-16. (canceled)

17. A shim for plugging a sleeve defining a blind cavity, the shim comprising:
a body comprising a rod, the body being suitable for being placed in an inserted position in which the rod is inside the blind cavity;
a seal extending around the rod, the seal being suitable for plugging an annular space provided between the rod and the sleeve and for defining a chamber with the rod and a bottom of the blind cavity while the body is in the inserted position;
a passage passing through the body for conveying air between the chamber and the outside of the sleeve, when the body is in the inserted position;
a closure system suitable for adopting, while the body is in the inserted position:
a closed configuration in which the closure system closes the passage, so as to fluidically isolate the chamber from the outside of the sleeve; and
an open configuration in which the closure system enables the passage to convey air between the chamber and the outside of the sleeve.

18. The shim according to the claim 17, wherein:
the air passage comprises a distal orifice and a proximal orifice opposite the distal orifice, wherein the distal orifice opens into the chamber while the body is in the inserted position, and the proximal orifice opens to the outside of the sleeve while the body is in the inserted position,
the closure system comprises a plug suitable for adopting, while the body is in the inserted position:
a closed position in which the plug covers the proximal orifice, and
an open position in which the plug uncovers the proximal orifice.

19. The shim according to claim 17, wherein the air passage comprises a straight duct going from the proximal orifice to the distal orifice.

20. The shim according to claim 17, wherein:
the air passage comprises an additional orifice suitable for opening to the outside of the sleeve when the body is in the inserted position, the additional orifice being distinct from the proximal orifice,
the closure system comprises an additional plug suitable for adopting, while the body is in the inserted position:
a closed position in which the additional plug covers the additional orifice, while the plug is in the open position, and
an open position in which the additional plug uncovers the additional orifice, while the plug is in the closed position.

21. The shim according to claim 20, wherein the additional orifice is oriented perpendicular to the proximal orifice.

22. The shim according to claim 17, wherein the rod has a cylindrical outer surface suitable for been aligned with a radially outer edge of the seal.

23. The shim according to claim 22, wherein the seal is arranged relative to the cylindrical outer surface so as to be inserted in the blind cavity before the cylindrical outer surface.

24. The shim according to claim 17, wherein the body comprises an annular shoulder suitable for being in abutment on a annular edge of the sleeve defining an access to the blind cavity, while the body is in the inserted position.

25. The shim according to claim 17, further comprising a porous element arranged in the passage in order to allow air to pass and to block a resin.

26. The shim according to claim 17, further comprising a second seal extending around the rod, the second seal being suitable for plugging the annular space provided between the rod and the sleeve at the same time as the seal, while the body is in the inserted position.

27. A method of manufacturing a product, the product comprising a sleeve defining a blind cavity and a preform extending around the sleeve, the method comprising the following steps carried out in sequence using a shim according to claim 17 for plugging the sleeve:
placing the body in the inserted position;
putting the closure system into the closed configuration;
injecting a resin into the preform, while the preform is around the sleeve,
putting the closure system into the open configuration; and
extracting the body from the sleeve.

28. The method according to claim 27, wherein the product is a turbomachine blade or a portion of a turbomachine blade.

29. An assembly comprising:
a sleeve defining a blind cavity,
a shim according to claim 17 for plugging the blind cavity.

30. The assembly according to claim 29, wherein:
the rod has a cylindrical outer surface suitable for been aligned with a radially outer edge of the seal,
the seal is arranged relative to the cylindrical outer surface so as to be inserted in the blind cavity before the cylindrical outer surface,
the sleeve has a cylindrical inner surface that is complementary to the cylindrical outer surface.

31. A system for producing a product comprising a sleeve defining a blind cavity and a preform extending around of the sleeve, the system comprising:
an assembly according to claim 29,
a mould configured to form the preform using a resin injected inside the mould, while the assembly is inside the mould.

32. The system according to claim 31, wherein:
the air passage comprises an additional orifice suitable for opening to the outside of the sleeve when the body is in the inserted position, the additional orifice being distinct from the proximal orifice,
the closure system comprises an additional plug suitable for adopting, while the body is in the inserted position:
a closed position in which the additional plug covers the additional orifice, while the plug is in the open position, and
an open position in which the additional plug uncovers the additional orifice, while the plug is in the closed position,
the mould comprises a wall suitable for coming into contact with the additional plug, while the resin is injected inside the mould.
